(19) United States
(12) Patent Application Publication
(10) Pub. No.: US 2013/0345862 A1
(43) Pub. Date: Dec. 26, 2013

(54) DEVICE FOR REMOVING HEAT FROM AN AUTOMATED HANDLING DEVICE, IN PARTICULAR A HANDLING ROBOT, AND USE OF THE DEVICE

(71) Applicants: Peter Schlaich, Leonberg (DE); Corinna Pfeiffer-Scheer, Asperg (DE)

(72) Inventors: Peter Schlaich, Leonberg (DE); Corinna Pfeiffer-Scheer, Asperg (DE)

(21) Appl. No.: 13/994,825

(22) PCT Filed: Dec. 9, 2011
(86) PCT No.: PCT/EP2011/072346

§ 371 Date: Sep. 16, 2013

(30) Foreign Application Priority Data
Dec. 16, 2010 (DE) 10 2010 063 223.6

(51) Int. Cl. B25J 19/00

(52) U.S. Cl. CPC B25J 19/0054
USPC 700/245

(57) ABSTRACT

A device for discharging heat from an automated handling device, in particular from a handling robot, having a structure of the handling device and having at least one heat-generating device, in particular of a drive system, of the handling device. A suction device or positive-pressure device for respectively discharging and delivering air is provided, which device is disposed in operative connection with the at least one heat-generating device.

### FIELD

The present invention relates to a device for discharging heat from an automated handling device, in particular from a handling robot. The present invention further relates to the use of a device according to the present invention.

### BACKGROUND INFORMATION

A handling device is already commonly available and is used, for example, as a fully automated handling robot for the installation of components in production facilities. In the simplest case, the heat of the drive systems is discharged to the environment by thermal radiation of the structure of the handling device. Typical heat-generating devices are, in particular, the drive systems of the handling device, which are required, for example, in order to move gripper arms or to pivot workpieces or the like. In addition to simple radiation of heat via the structure of the handling device, heat is also given off to the environment of the handling device by the fact that air present in the handling device is heated by the heat-generating device and escapes from the handling device in particular through unsealed points, for example in the region of axial drive systems or the like.

German Patent Application No. DE 20 2005 002 475 U1 describes providing on an industrial robot a foamed-material cover that diminishes collision force. This kind of configuration of an industrial robot creates the problem that heat can be given off to the environment only to a certain limited extent, since the foamed-material cover results in insulation of the handling device. The stress on the components disposed in the handling device is thereby increased because of the relatively high internal temperature of the handling device; this can be critical in particular for electronic components.

It is moreover problematic that dust, dirt, or the like can get into the interior of the handling device by way of the axial drive systems of handling devices, which usually exhibit unsealed points, in particular when the handling devices are used, for example, in dusty production locations, the result being to reduce the functionality or service life of the handling device. Conversely, when handling devices are used in a production area that imposes increased air cleanliness requirements, for example in production areas in the pharmaceutical industry or the semiconductor industry, the risk exists that contaminated air may travel via the aforesaid unsealed points of the handling device from the interior of the structure of the handling device into the manufacturing device or the production area.

### SUMMARY

An object of the present invention is to refine a device for discharging heat from an automated handling device, in particular from a handling robot in such a way that it can be used in particular in areas or spaces that either require particular cleanliness conditions or air quality levels, or that are notable for a particularly high level of contaminants, for example in the form of dust. A further object is also to enable operation at relatively high temperatures that would otherwise, because of the high temperature of the drive system parts that is usually associated therewith, would result in a stoppage of the handling device. In accordance with example embodiments of the present invention, a suction device or blowing device is provided for respectively discharging or delivering air, which device is disposed in operative connection with the at least one heat-generating device in the handling device. A capability is thus provided for actively removing heat by extracting or blowing it out of the handling device. The heat stress on the handling device, and the heat stress on the components, is thereby additionally reduced.

All combinations of at least two features described below, and/or shown in the figures lie within the scope of the present invention.

An example configuration of the present invention that is of particularly simple design and that generates a sufficiently large air flow, in the context of air-tight structures of the handling device, to discharge the heat generated in the structure at least in regions in which the heat produces no damage or negative effects, is achieved when the structure is embodied as an at least approximately air-tight structure, and when the suction device or positive-pressure device is connected to the structure in particular in the region of a column.

In order to make it possible, in the context of handling devices that usually are not of air-tight configuration, for the air intended for heat discharge to reach the location at which the heat is generated, in a further particularly preferred design configuration it is moreover proposed that there be provided within the structure an, in particular, hose-shaped or tubular element that is coupled to the suction device or positive-pressure device and is in operative connection with the heat-generating device disposed in the interior of the structure.

Particularly preferably, provision is made in this context that the element has in a longitudinal dimension at least one perforation, preferably multiple perforations. This makes possible, over the entire extent of the element, a capability for extracting heated air or delivering cooling air at critical locations.

A uniform heat flux is achieved if the size or diameter or number of the perforations changes in the longitudinal direction of the element.

Conventional handling devices may have, for example, a pneumatically operated gripper arm. A pneumatically operated gripper arm of this kind is actuated or controlled by way of a connecting hose through which negative or positive pressure is directed to the gripper arm. In a further embodiment of the present invention, provision is therefore made that the element is a connection to a pneumatically operated drive system of the handling device. This means that the hose necessary in any case for operation of the drive system is at the same time used to discharge heat. The result is in particular that an increased space requirement in the interior of the structure of the handling device is not necessary, and the additional investment costs increase only minimally.

In a further embodiment of the present invention, the structure is surrounded by a sensorial cladding. Because such a structure generally acts in heat-insulating fashion with respect to the exterior, the example device according to the present invention thus makes it possible to operate the handling device without having the components of the handling device reach a critical temperature.

The present invention also encompasses the use of an example device according to the present invention in areas having elevated air cleanliness requirements, in particular in clean rooms, as well as use in contaminated areas.

Further advantages, features, and details of the invention are described below in the context of preferred exemplifying embodiments and on the basis of the figures.

### BRIEF DESCRIPTION OF THE DRAWINGS

FIG. 1 shows a simplified depiction of a handling device, embodied as a handling robot, in a clean room.

FIG. 2 is a detail of a modified handling device utilizing a hose-shaped element to discharge heat.

### DETAILED DESCRIPTION OF EXAMPLE EMBODIMENTS

Identical components or components having an identical function are labeled in the Figures with the same reference numbers.

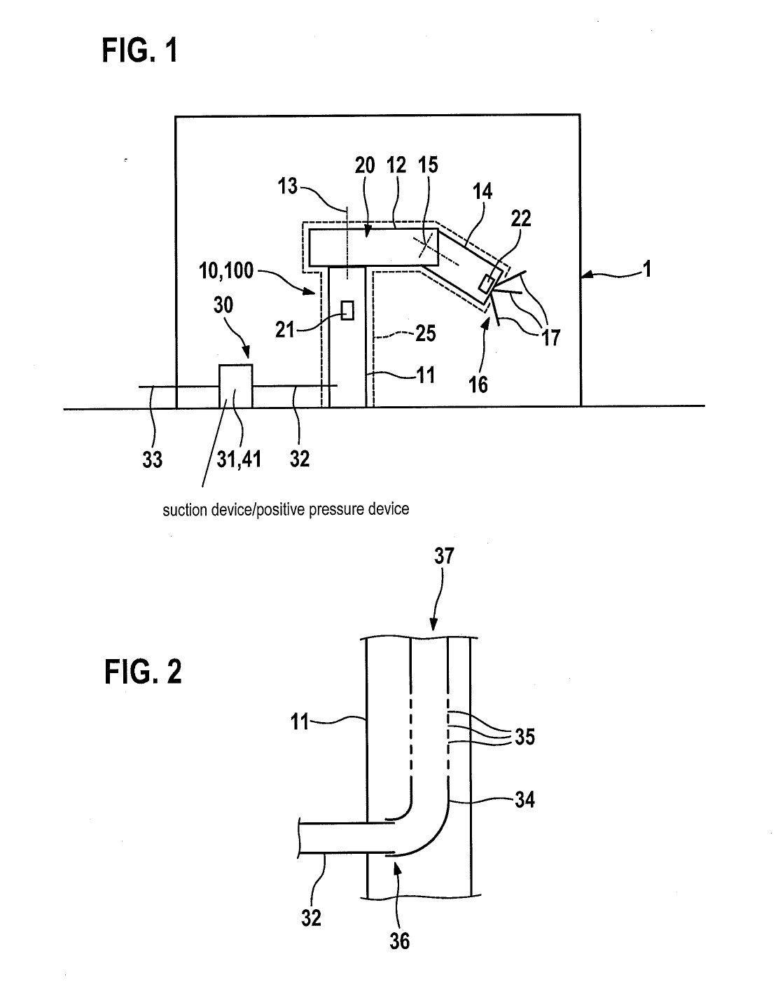

FIG. 1 is a simplified depiction of an automated handling device 100 in the form of a handling robot 10. Handling robot 10 serves, by way of example and therefore in non-limiting fashion, to install or assemble parts in a production area 1.

Handling robot 10 has a column 11 that is connected to the floor of production area 1. Disposed at the upper end surface of column 11 is a first pivot arm 12 that is mounted pivotably in a rotation axis 13. Disposed on first pivot arm 12 on the side opposite to column 11 is a second pivot arm 14 that is pivotable in a rotation axis 15. Second pivot arm 14 carries, by way of example, a gripper device 16 having gripper fingers 17. The components of handling robot 10 that have so far been described constitute the (external) structure 20 of handling robot 10. Disposed inside structure 20 of the handling robot, i.e. for example inside column or inside second pivot arm 14, are heat-generating devices in the form of drive systems 21, 22. First drive system 21 serves, by way of example, to rotate first pivot arm 12 on column 11, while second drive system 22 serves, for example, as a pneumatic drive system 22 to actuate gripper fingers 17 of gripper arm 16.

Provision can optionally be made that structure 20 is surrounded by a sensorial cladding 25 (merely indicated). Cladding 25 surrounds structure 20 at least in part, but preferably completely, and serves to correspondingly adapt, for example to stop, the operation of handling robot 10 in the event of an impending collision of handling robot 10 with, for example, objects or persons that are in the vicinity of handling robot 10. Cladding 25 encompasses for this purpose sensorial devices, for example proximity sensors, deformation sensors, or the like.

Handling robot 10 has a device 30 for discharging heat from the heat-generating drive systems 21, 22. In the exemplifying embodiment depicted in FIG. 1, device 30 encompasses a suction device 31 that is connected via a first conduit 32 to column 11 or opens thereinto. A second conduit 33 connects suction device 31 to an environment outside production area 1. First conduit 32 is sealingly connected to column 11 and projects to only a small extent into column 11 (FIG. 2). Air that is present inside structure 20 and is heated by drive systems 21, 22 is extracted by way of suction device 31 out of structure 20 and given off to the environment outside production area 1. A prerequisite for an embodiment of this kind, in which first conduit 32 projects to only a small extent into column 11, is that structure 20 be constructed in its interior in such a way that the negative pressure generated in the region of the connection point of first conduit 32 in column 11 is effective as far as drive systems 21, 22. If that is not the case, then in accordance with FIG. 2, first conduit 32 can be coupled to a hollow element 34, for example a flexible hose or a tube, disposed inside structure 20. Element 34 can have an inside diameter of between 1 mm and 5 mm, in particular between 3 mm and 4 mm. In addition, perforations 35 are embodied in the wall of element 34, their disposition and size being such that, in particular, air can be extracted in the region of the heat-generating drive systems 21, 22.

Provision can also be made that perforations 35 increase steadily, in terms of their number and size, in the direction from connection point 36 toward hose end 37, in order to enable uniform extraction of air within structure 20 at every point in structure 20.

An embodiment of device 30 in which a suction device 31 for discharging heat from the heat-generating drive systems 21, 22 is provided is preferably used in sealed structures 20. The axial drive systems in particular, i.e., the connecting points between column 11 and first pivot arm 12, between first pivot arm 12 and second pivot arm 14, and between second pivot arm 14 and gripper arm 16, are of sealed configuration. In addition, a suction device 31 is also used in the context of non-sealed structures 20 when handling robot 10 is located inside a production area 1 having elevated cleanliness requirements. Examples that may be recited here are production areas 1 in the pharmaceutical industry or in the processing of semiconductor elements. In this case the use of a suction device 31 ensures that handling robot 10 does not give off its waste heat into production area 1. In addition, a suction device 31 also makes sense when the aforementioned sensor skin 25 is used, since the latter usually has the effect of thermally shielding structure 20 from the outside, which at least complicates discharge or radiation of the heat of the heat-generating drive systems 21, 22.

In the exemplifying embodiment described above, element 34 is embodied as a separate, additional element 34. It is, however, also possible and useful to use element 34 simultaneously to drive, for example, second drive system 22 for gripper arm 16. In this case element 34 serves to control and to supply the pneumatically driven gripper arm 16. Element 34 then has the (additional) perforations 35; this must of course be taken into account in the context of the design and actuation of the pneumatic drive system of gripper arm 16.

If production area 1 is an area in which air quality is contaminated as a result of particles, e.g., dust, or aggressive media, it is useful to use, instead of a suction device 31, a positive-pressure device 41 for generating compressed air. This positive-pressure device 41 is also preferably equipped with a second conduit 33 that aspirates (clean) air from a region outside production area 1. When a positive-pressure device 41 is used to generate compressed air, it is useful or necessary for structure 20 to have unsealed points so that the compressed air blown into structure 20 by positive-pressure device 41 can escape from structure 20. This usually occurs via the unsealed points in the region of the aforesaid axial drive systems. This has the particular advantage that because compressed air is used, contaminated air from production area 1 cannot enter structure 20, i.e., in particular that the axial drive systems are, for example, protected by the compressed air from the entry of dust or the like.

Handling device 100 and handling robot 10 so far described can be varied or modified in many ways without deviating from the basis of the present invention.

1-10. (canceled)

11. A device for discharging heat from an automated handling device, comprising:
a structure of the handling device and at least one heat-generating device of the handling device; and
one of a suction device or positive-pressure device for respectively discharging and delivering air disposed in operative connection with the at least one heat-generating device.

12. The device as recited in claim 11, wherein the at least one heat-generating device includes a drive system.

13. The device as recited in claim 11, wherein the automated handling device is robot.

14. The device as recited in claim 11, wherein the structure is an at least approximately air-tight structure, and the suction device or positive-pressure device is connected to the structure in a region of a column.

15. The device as recited in claim 11, wherein provided within the structure is one of a hose-shaped or tubular element that is coupled to the suction device or positive-pressure device and is in operative connection with the heat-generating device disposed in the interior of the structure.

16. The device as recited in claim 15, wherein the element is a flexible hose and has an inside diameter from 1 mm to 5 mm.

17. The device as recited in claim 15, wherein the element is a flexible hose and has an inside diameter from 3 mm to 4 mm.

18. The device as recited in claim 15, wherein the element has, in a longitudinal dimension of the element, at least one perforation.

19. The device as recited in claim 18, wherein the at least one perforation includes a plurality of perforations.

20. The device as recited in claim 18, wherein one of a size, diameter, or number of the perforations changes in the longitudinal direction of the element.

21. The device as recited in claim 15, wherein the element is a connection to a pneumatically operated drive system of the handling device.

22. The device as recited in claim 15, wherein the structure is surrounded by a cladding acting sensorially as collision protection.

23. A method, comprising:
providing an automated handling device, the automated handling device including a structure of the handling device and at least one heat-generating device of the handling device, and one of a suction device or positive-pressure device for respectively discharging and delivering air disposed in operative connection with the at least one heat-generating device; and
using the automated handling device in an area having elevated air cleanliness requirements.

24. A method, comprising:
providing an automated handling device, the automated handling device including a structure of the handling device and at least one heat-generating device of the handling device, and one of a suction device or positive-pressure device for respectively discharging and delivering air disposed in operative connection with the at least one heat-generating device; and
using the automated handling device in an area contaminated with particles or with aggressive media.
